(19) United States
(12) Patent Application Publication
(10) Pub. No.: US 2023/0287587 A1
(43) Pub. Date: Sep. 14, 2023

(54) WATER ELECTROLYZER

(71) Applicant: EVOLOH, INC., Palo Alto, CA (US)

(72) Inventors: Jimmy Andrey ROJAS HERRERA, Palo Alto, CA (US); Ashutosh Ganesh DIVEKAR, Palo Alto, CA (US); Philipp Karl MUSCHER, Palo Alto, CA (US); Taylor HUFF, Palo Alto, CA (US)

(73) Assignee: EVOLOH, INC., Palo Alto, CA (US)

(21) Appl. No.: 18/040,514

(22) PCT Filed: Aug. 5, 2021
(86) PCT No.: PCT/US2021/044703

§ 371 Date: Feb. 3, 2023

Related U.S. Application Data
(60) Provisional application No. 63/062,041, filed on Aug. 6, 2020.

(51) Int. Cl. C25B 13/08; C25B 1/04; C25B 11/061; C25B 9/75; C25B 9/77; C25B 11/081

(52) U.S. Cl. CPC C25B 13/08; C25B 1/04; C25B 11/061; C25B 9/75; C25B 9/77; C25B 11/081

(57) ABSTRACT

The present application relates to water electrolyzers, including water electrolyzers incorporating anion exchange membranes. The present applications also relates to materials incorporated into water electrolyzers and approaches for manufacturing water electrolyzers, as well as methods of using water electrolyzers.

### INCORPORATION BY REFERENCE OF RELATED APPLICATIONS

This application is based upon and claims priority under 35 U.S.C. § 119(e) to U.S. provisional application U.S. Ser. No. 63/062,041 filed Aug. 6, 2020, the entire contents of all of which are incorporated herein by reference in their entirety.

### FIELD OF THE INVENTION

The present application relates to water electrolyzers, including water electrolyzers incorporating anion exchange membranes. The present application also relates to materials incorporated into water electrolyzers and approaches for manufacturing water electrolyzers, as well as methods of using water electrolyzers.

### BACKGROUND

Water electrolysis, also known as “water splitting,” is the decomposition of liquid water (H₂O) into oxygen gas (O₂) and hydrogen gas (H₂). At a high level, water electrolysis is accomplished by passing an electric current through water at a voltage of at least 1.23V applied across an anode and a cathode. Hydrogen gas is produced at the cathode and oxygen gas is produced at the anode. Hydrogen gas plays a key role in industrialized society both as a direct (alternative) energy source and reagent in many important industrial processes, including the Haber process (for producing ammonia used to make most agricultural fertilizers). Oxygen gas may also be used as an oxidizing reagent or simply as a component of breathable air. For example, astronauts and cosmonauts residing at the International Space Station (ISS) rely on water electrolysis to maintain their life-supporting oxygen supply.

Simple water electrolysis using only pure water and metal electrodes, however, does not efficiently generate hydrogen and oxygen because the current density permitted by this design is much too low for practical use. As a result, two primary water electrolysis approaches are currently used, which permit much greater current densities, and thus generate much more gaseous product: alkaline electrolysis and proton exchange membrane (PEM) electrolysis. Both approaches have significant drawbacks, however. Alkaline electrolyzers are less efficient than PEM approaches and require use of liquid electrolyte, increasing initial capital expenditure and balance of plant (supporting components and auxiliary systems) and requiring a larger plant to produce the same material output. PEM electrolyzers, while being more efficient than alkaline electrolyzers and being able to use pure water, operate in acidic environments requiring much more expensive anode and cathode materials and catalysts (e.g., platinum-group metal electrode and catalysts), significantly increasing initial capital expenditure. Other water electrolysis techniques also exist, such as anion exchange membrane electrolyzers (AEMELs) utilizing corrosive electrolytes such as KOH or NaHCO₃. Due to the requirement of corrosive electrolytes, such systems do not significantly improve on the current state of the art systems used industrially. As a result, the vast majority of commercial hydrogen is not produced using water electrolysis approaches. Instead, most industrial hydrogen is generated by non-renewable approaches such as steam reforming of natural gas, partial oxidation of methane, and coal gasification.

In contrast to these non-renewable approaches, water electrolysis can be performed in a complete carbon-neutral manner and can generate 100% renewable hydrogen energy. Furthermore, water electrolysis can produce hydrogen domestically without using fossil fuels, meaning water electrolysis can also severely reduce or eliminate dependence on foreign energy sources and/or the need to utilize strategic fossil fuel reserves. Because current water electrolysis technology is not economically efficient enough to compete with non-renewable approaches, however, there is a strong need to develop improved water electrolysis approaches.

### SUMMARY

Recognizing the need for improved water electrolysis, the inventors of the present application have developed novel water electrolyzers, electrolyzer materials, and related methods that greatly reduce the cost of industrial water electrolysis while maintaining high current density.

Thus, in one aspect the present application provides a water electrolyzer. In a preferred embodiment of the application, the water electrolyzer is an anion exchange membrane water electrolyzer (or an AEMEL) which uses a solid polymer anion exchange membrane and pure water, thus requiring no liquid electrolyte (e.g., no alkaline electrolytes like KOH or NaHCO₃) as shown in FIG. 1. A preferred construction of such an AEMEL includes end plates, between which are arranged “n” electrochemical cells each with its own gas diffusion layer, membrane, and porous transport layer, while being separated from each other by a bipolar plate (sometimes known as middle plate), as shown in FIG. 2. The number of cells, “n”, can be 1 (known as a single cell) or multiple (known as a stack).

The water electrolyzers of the present application eliminate the disadvantages of current approaches. First, because these water electrolyzers utilize pure water without liquid electrolyte and do not operate in an acidic environment, they can be built using low-cost materials, such as stainless steel and nickel, unlike PEMELs. Second, because they do not use liquid electrolyte, the water electrolyzers of the present application have a simple balance of plant (supporting components and auxiliary systems) and are able to produce pressurized hydrogen gas (FIG. 3), unlike alkaline water electrolyzers (FIG. 4). Third, the water electrolyzers of the present application can be operated at high current densities and can be constructed in space-saving efficient stacks, unlike alkaline water electrolyzers. Fourth, the water electrolyzers of the present application use non-precious metals, such as molybdenum, tin, cobalt, nickel, copper, iron, etc., as compared to current industrial electrolyzers such as PEMELS, which rely on precious metals like platinum, iridium, ruthenium, silver. Fifth, the flow fields of the cells in the water electrolyzers of the present application have been engineered as a simpler quadrilateral pocket with optimized thickness that improves the flow of molecules while also reducing manufacturing steps and costs, unlike the complex flow field designs (e.g., single serpentine, multi-serpentine, parallel, pin-type/grid) associated with current industrial PEM electrolyzers or fuel cells.

Further objects, features, and advantages of the present application will become apparent form the detailed description which is set forth below.

### BRIEF DESCRIPTION OF THE DRAWINGS

FIG. 1 depicts the general structure of the (single-cell diagram) anion exchange membrane water electrolyzer of the present application. As shown, water is fed only at the anode side.

FIG. 2 depicts the general structure of a water electrolyzer stack.

FIG. 3 depicts a process flow diagram of an AEMEL according to the present application.

FIG. 4 depicts a process flow diagram of a typical AEL.

FIG. 5 depicts two common ink spray-coating methodologies in the fabrication of electrodes for anion exchange membrane water electrolyzers.

FIG. 6 depicts two styles of pocket-like flow fields. a) Two current collectors and one pocket flow field. The flow field allows the water and/or gases to flow from inlet to outlet through an open empty space occupied only by the diffusion layers (PTL or GDL). No flow pattern is observed. b) a simple pocket flow field where water can flow in (if anode) or nothing flows in (cathode), and hydrogen can exhaust (if cathode) or a mixture of oxygen and water (anode). No flow pattern is observed.

FIG. 7 depicts a process flow diagram of a non-precious metal catalyst preparation strategy for an AEMEL.

FIG. 8 depicts voltage data over time for an AEMEL cell functioning with pure water and maintaining a dry cathode.

### DETAILED DESCRIPTION OF CERTAIN EMBODIMENTS

### Definitions

The term “AEL” when used in this application refers to alkaline water electrolyzes. The term “AEM” when used in this application refers to an anion exchange membrane. The term “AEMEL” when used in this application refers to an anion exchange membrane water electrolyzer. The term “ionomer” when used in this application refers to the polymer that may be casted to produce the AEM and may also be also used to create the ink to create the electrodes. The term “GDL” when used in this application refers to a gas diffusion layer. The term “PEM” when used in this application refers to a proton exchange membrane. The term “electrode substrate” when used in this application refers to the PTL or GDL when coated with ink. The term “PEMEL” when used in this application refers to a proton exchange membrane water electrolyzer. The term “PTL” when used in this application refers to a porous transport layer. The term “ink” when used in this application refers to the mixture of ionomer, catalyst, additives, and solvents used to coat the AEM, PTL and/or GDL. The term “CCM” when used in this application refers to catalyst coated membrane (process in which the ink is coated on the membrane). The term “CCE” when used in this application refers to catalyst coated electrode (process in which the ink is coated on the PTL or GDL). The term “CCS” when used in this application refers to catalyst coated substrate (process in which the ink is coated on the PTL or GDL). CCE and CCS are identical, and the words can be used interchangeably. The term “FeNiO” refers to Iron Nickel oxide, it may also be written as Ni_{y}Fe_{1-y}Oₓ depending on the amount of each metal.

It should be understood the term “electrode” may refer to either the anode or the cathode of an electrolyzer or both. Furthermore, where the ink is coated on the GDL and/or the PTL, the electrode may also as a practical matter encompass those layers.

Water Electrolyzers

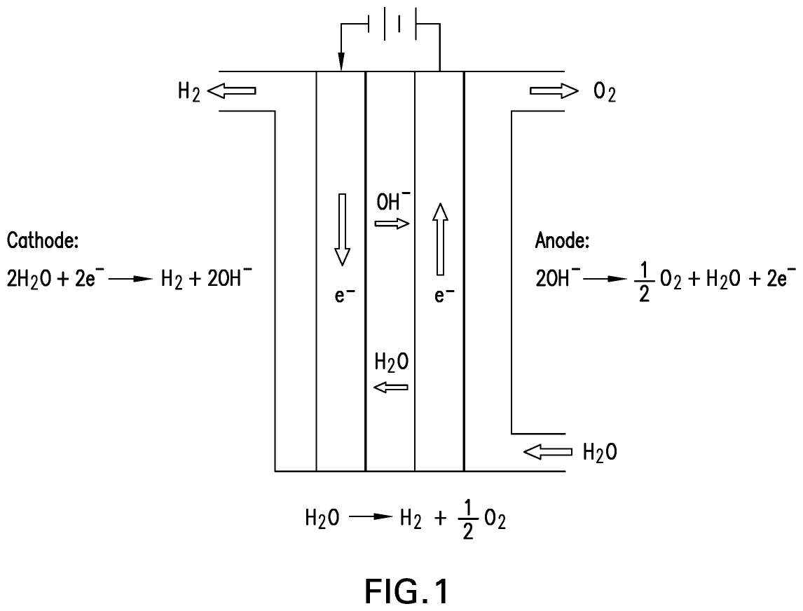

In one aspect, the present application provides water electrolyzers. In a preferred embodiment of the application, the water electrolyzer of the present application is in the form of an anion exchange membrane (AEM) water electrolyzer, or an AEMEL, which uses a solid polymer anion exchange membrane electrolyte and pure water, thus requiring no liquid electrolyte (e.g., no alkaline electrolytes like KOH or NaHCO₃). A general and simplified example of an AEMEL is depicted in FIG. 1.

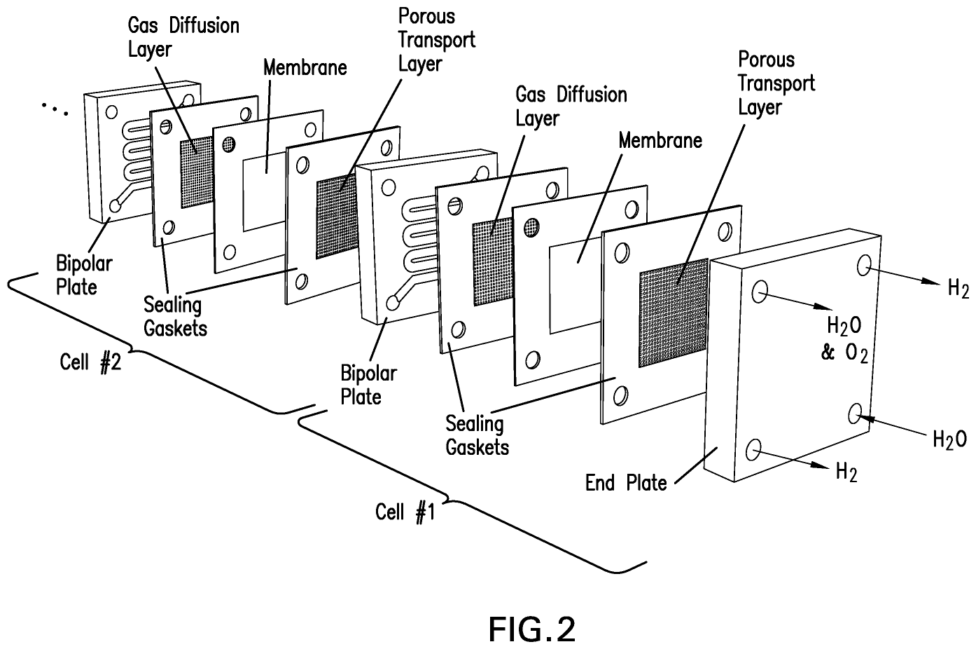

The AEMEL of the present application includes an anode and a cathode, between which a voltage is applied to electrolyze water. Between the bipolar plates are arranged a plurality of additional layers, including in some embodiments a gas diffusion layer, a membrane, and/or a porous transport layer, all of which could be coated with ink (although none is specifically required). An example of a preferred configuration of an AEMEL according to the present application is shown in FIG. 2, where the ellipsis shows multiple cells arranged in series into an electrolyzer stack.

In one embodiment, the AEMEL of the present application includes an anode plate, a cathode plate, and multiple bipolar plates (also known as middle plates). One purpose of these plates is to transport liquids and gases in and out of the cell. In one embodiment, a single component may act as both an anode plate and cathode plate, especially in a series of stacked AEMEL cells, and is called bipolar plate or middle plate. In another embodiment, there may be separate components for each cell which are the anode plate and the cathode plate.

In one embodiment, the middle plate (or bipolar plate) is made of metal. In some embodiments, the middle plate is made of coated or uncoated aluminum, nickel, copper, zinc, and/or stainless steels (e.g., SS 304, SS 316, SS 430, SS A-286, etc.). In some embodiments, the middle plate may be coated with layers of metals, including nickel, gold, titanium, platinum, steel, ruthenium, iridium, silver, aluminum, copper, zinc, or another metal, or combinations thereof. In some embodiments, the middle plate is made of a non-metal component, (e.g., a ceramic or plastic) which has been coated with a metal or with layers of metals as described above.

In a preferred embodiment, the middle plates, also known as bipolar plates, comprise a single component with pocket flow fields on both sides to transport liquids and gases. In a preferred embodiment, the middle plates are made of stainless steel, most preferably stainless steel type 316, although other types of stainless steel (or other metals) may also be used in view of engineering and materials considerations (e.g., coefficient of thermal expansion, electrical resistance, etc.).

In one embodiment, the anode plate is made of metal. In some embodiments, the anode is made of coated or uncoated aluminum, nickel, copper, zinc, and/or stainless steels (e.g., SS 304, SS 316, SS 430, SS A-286, etc.). In some embodiments, the anode plate may be coated with layers of metals, including nickel, gold, titanium, platinum, steel, ruthenium, iridium, silver, aluminum, copper, zinc, or another metal, or combinations thereof.

In a preferred embodiment, the anode plate is a stainless steel plate with a pocket flow field to transport liquids and gases, most preferably stainless steel type 316, although other types of stainless steel (or other metals) may also be used in view of engineering and materials considerations (e.g., coefficient of thermal expansion, electrical resistance, etc.).

In an embodiment of the present application, water is fed into the AEMEL. In a preferred embodiment, water is fed at the anode side. Thus, in certain embodiments the anode plate may have a flow field to allow water to be fed into the AEMEL at the anode side. The flow field and/or the inlet may be directly machined on the anode's plate or may be provided as a separate structure which can be attached to the anode plate. The flow field may simply be a pocket where the water can randomly be distributed within the porous transport layer. In an AEMEL, oxygen gas is produced at the anode. In certain embodiments, the anode may have a pocket flow field arranged for oxygen in the anode plate with an outlet to allow oxygen to flow out of the AEMEL at the anode side. The flow field (either pocket or another specific pattern) and/or the outlet may be machined on the anode's plate or may be provided as a separate structure which can be attached to the anode plate. The flow field for water and the flow field for oxygen may be connected or may be separate.

In one embodiment, the cathode plate is also made of metal. In another embodiment, the cathode plate is made of graphite. In some embodiments, the cathode plate is made of coated or uncoated aluminum, nickel, copper, zinc, and/or stainless steels (e.g., SS 304, SS 316, SS 430, SS A-286, etc.). In some embodiments, the cathode plate may be coated with layers of metals, including nickel, gold, titanium, platinum, steel, ruthenium, iridium, silver, aluminum, copper, zinc, or another metal, or a combination thereof.

In a preferred embodiment, the cathode plate is a stainless steel plate with a pocket flow field to transport liquids and gases, most preferably stainless steel type 316, although other types of stainless steel (or other metals) may also be used in view of engineering and materials considerations (e.g., coefficient of thermal expansion, electrical resistance, etc.).

In an AEMEL, hydrogen gas is produced at the cathode. Because the cathode in the AEMEL of the present application may be configured as a dry cathode, the hydrogen may be produced at the cathode at a pressure higher than ambient pressure (e.g., 1 atm at sea level). In one embodiment, the cathode may have a flow field arranged therein having an outlet to allow hydrogen to flow out of the AEMEL at the cathode side. The hydrogen may flow out of the cathode at a pressure higher than ambient pressure, facilitating easy storage in specialized containers, which containers may be pressurized. The hydrogen flow field and/or the outlet may be machined on the cathode or may be provided as a separate structure which can be attached to the cathode plate. In a preferred embodiment, the cathode is a dry cathode. At a dry cathode, no liquid is present other than water.

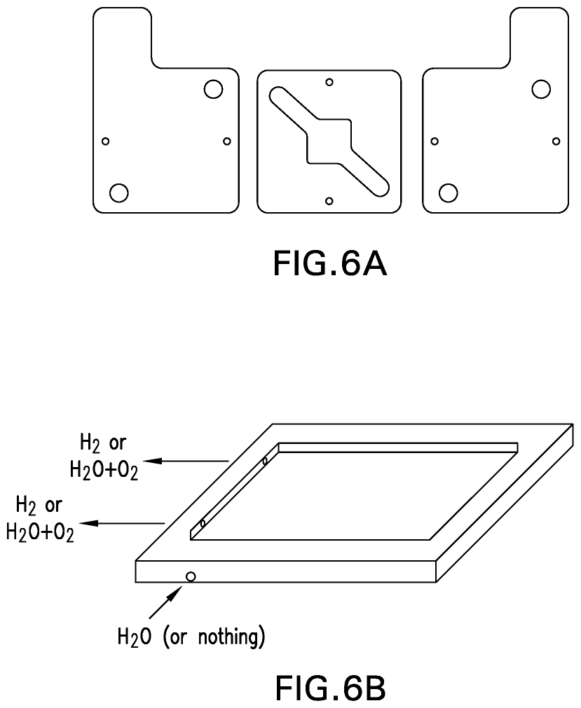

In one embodiment, the anode plates, middle plates, and cathode plates may have a serpentine flow field design, a multiple-serpentine flow channel design, a parallel flow field design, an interdigitated flow field design, a pocket flow field design, or a combination thereof. In all cases, these fields are used to transport liquids and gases in and out of the cells. The pocket flow field does not have any machined pattern to direct the flow of liquids and gases. In other words, the direction of the flow is not constraint by grooves (as is the case with the serpentine pattern flow field, for example). Instead, it accommodates the diffusion layers (PTL or GDL) and allows the gas and/or liquid flow to occur only through the pores of these diffusion layers as exemplified in FIG. 6. If placed correctly, multiple water inlets may constructively create a constant flow across the active area.

In a preferred embodiment, the anode plate, middle plates, and cathode plates have pocket flow fields engineered to optimize fluid flow through the diffusion layers, minimize pressure drops, and maximize cell lifetime.

In a preferred embodiment of the present application, the AEMEL includes a plurality of layers arranged between the anode and the cathode. The plurality of layers includes a gas diffusion layer, a porous transport layer, and/or an anion exchange membrane. Those of ordinary skill in the art will understand each of these layers may themselves be composed of multiple material layers. An example of the arrangement of these layers in an AEMEL according to the present application is shown in FIG. 2.

In an embodiment of an AEMEL according to the present application, the gas diffusion layer is present to facilitate the transport of gas and is arranged adjacent to the cathode. Thus, the gas diffusion layer may facilitate the transport of in particular hydrogen gas. In some embodiments, the gas diffusion layer is made of titanium, aluminum, carbon (e.g., carbon paper, carbon fiber composite, graphite felt, graphene, carbon cloth, etc.), nickel, copper, zinc, stainless steels (e.g., SS 304, SS 316, SS 316L, SS 430, SS A-286, etc.), other materials, or a combination thereof. In some embodiments, the gas diffusion layer may be coated or uncoated. In some embodiments, the gas diffusion layer may be wet proofed in order to increase its hydrophobic properties. In some embodiments, the gas diffusion layer may include a microporous layer to improve water-repellent properties and improve catalyst adhesion. In some embodiments, the gas diffusion layer has a nanostructure or a microstructure. In some embodiments, the gas diffusion layer is formed of nanowires, microfibers, or cloths. In some embodiments, the gas diffusion layer is formed using foams. In some embodiments, the gas diffusion layer is electrically connected to the cathode material, such that the gas diffusion layer effectively forms a part of the cathode. In some embodiments, multiple layers of different porosities may be stacked to maximize the water and gas transport of the gas diffusion layer. In some embodiments, the gas diffusion layer may include additives such as fluorinated ethylene propylene (FEP), polytetrafluoroethylene (PTFE), perfluoroalkoxy polymer resin (PFA), or polyvinylidene difluoride (PVDF).

In a preferred embodiment, the gas diffusion layer comprises carbon paper(s) (such as molded graphite laminates or carbon fiber) or nickel sheet(s) (foams or fibers) or stainless steel sheet(s) (foams or fibers).

In an AEMEL according to the present application, the porous transport layer is present to facilitate the transport of liquids and gases and is arranged adjacent to the anode. Thus, the porous transport layer may facilitate the transport of, in particular, water and ions dissolved in water, as well as the produced oxygen. In some embodiments, the porous transport layer is made of titanium, aluminum, carbon (e.g., carbon paper, carbon fiber composite, graphite felt, graphene, carbon cloth, etc.), nickel, copper, zinc, stainless steels (e.g., SS 304, SS 316, SS 316L, SS 430, SS A-286, etc.), other materials, or a combination thereof. In some embodiments, the porous transport layer may be coated or uncoated. In some embodiments, the porous transport layer may be wet proofed in order to increase its hydrophobic properties. In some embodiments, the porous transport layer may include additives such as fluorinated ethylene propylene (FEP), polytetrafluoroethylene (PTFE), perfluoroalkoxy polymer resin (PFA), or polyvinylidene difluoride (PVDF). In some embodiments, the porous transport layer may include a microporous layer to improve water-repellent properties and improve catalyst adhesion. In some embodiments, the porous transport layer has nanostructure or a microstructure. In some embodiments, the porous transport layer is formed of nanowires, microfibers, or cloths. In some embodiments, the porous transport layer is formed using foams. In some embodiments, the porous transport layer is electrically connected to the anode material, such that the porous transport layer effectively forms a part of the anode. In some embodiments, multiple layers of different porosities may be stacked to maximize the water and gas transport of the porous transport layer.

In a preferred embodiment, the porous transport layer comprises nickel foam(s) or microfiber felt(s).

In an AEMEL of the present application, the anion exchange membrane (AEM) is a semipermeable membrane designed to permit the flow of anions (such as OH⁻) and water while and prevent the flow of gases (such as H₂ and O₂ produced at the cathode and anode). An anion exchange membrane is made by casting an ionomer solution. As discussed below, certain embodiments of the present application also use ionomers as resin for a catalyst ink. The catalyst and/or catalyst ink (discussed in more detail below) also include ionomers.

Thus, in some embodiments, the ionomers used in the present application are polymers. In one embodiment, the ionomer accounts for as much as 45 wt % (or less) as part of the catalyst ink (defined as the catalyst, ionomer, and additives mixture, but excluding solvents or water). In one embodiment, the ionomer of the AEM and/or the catalyst ink is a polymer based on poly(aryl piperidinium) which consists of either a piperidone monomer or a 3-oxo-6-azoniaspiro[5.5]undecane salt monomer, an aromatic and, optionally, a trifluoroacetophenone monomeric group. It may also be functionalized with quaternary ammonium cationic groups such as trimethyl ammonium or methyl piperidinium cations. In one embodiment, the ionomer of the AEM and/or the catalyst ink are an ionomer, or a polymer based on a styrene-butadiene block copolymers (SEBS) with a tethered quaternary ammonium group through aromatic ring(s). In one embodiment, the ionomer of the AEM and/or the catalyst ink are a multiblock copolymer comprising one or more norbornene-based hydrophilic blocks, one or more norbornene-based or alkene-based hydrophobic blocks, and functionalized with quaternary ammonium cation groups (such as trimethyl ammonium). In one embodiment, the ionomer of the AEM and/or the catalyst ink are trimethyl or benzyl trimethyl ammonium functionalized polystyrene ionomers with different molar percentages of quaternized benzyl ammonium. In one embodiment, the ionomer of the AEM and/or the catalyst ink are comprised of hexamethyl trimethyl ammonium-functionalized Diels-Alder polyphenylene (HTMA-DAPP). In one embodiment, the ionomer of the AEM and/or the catalyst ink are an ionomer that uses the tetrakis(dialkylamino)phosphonium cation as a functional group. In one embodiment, the ionomer of the AEM and/or the catalyst ink are a polyethylene based triblock copolymer, polychloromethylstyrene-b-polyethylene-b-polychloromethylstyrene (PCMS-b-PE-b-PCMS) quaternized with either trimethyl ammonium or methylpiperidinium cation. In one embodiment, the ionomer of the AEM and/or the catalyst ink are an ionomer or polymer comprising a cationic benzimidazolium or imidazolium-containing moieties. In one embodiment, the ionomer of the AEM and/or the catalyst ink are an ionomer based on hexamethyl-p-Terphenyl Poly(benzimidazolium). In one embodiment, the ionomer of the AEM and/or the catalyst ink are an ionomer or a polymer with a 3M-PFSA(EW 798) precursor containing a copolymer of a tetrafluoroethylene (PTFE) and a trifluoroethylene functionalized with a perfluorinated sulfonyl fluoride carbon chain. The trimethylammonium or an imidazolium cation is tethered to the sulfonamide through a six-carbon alkyl spacer chain. In another embodiment, the AEM and/or the catalyst ink of the present application may include PPN (polyphenylene) ionomer or membrane or PAP (polyaryl piperidinium) ionomer or membrane. In one embodiment, the ionomer of the AEM and/or the catalyst ink consist of ethylene tetrafluoroethylene (ETFE), or low-density polyethylene (LDPE), or high-density polyethylene (HDPE) irradiated with e-beam. It may be tethered by quaternary ammonium cationic groups such as trimethyl ammonium, or benzyl trimethyl ammonium, or N-methylpyrrolidine, or N-methylpiperidine. The polymer may be grafted with vinyl benzyl chloride (VBC) or other vinyl alkyl or aromatic chlorides.

In a preferred embodiment, the AEM and/or the catalyst ink comprises a polymer based on poly(aryl piperidinium) which consists of either a piperidone monomer or a 3-oxo-6-azoniaspiro[5.5]undecane salt monomer, an aromatic and, optionally, a trifluoroacetophenone monomeric group.

In another preferred embodiment, the AEM and/or the catalyst ink comprises a multiblock copolymer comprising one or more norbornene-based hydrophilic blocks and one or more norbornene-based or alkene-based hydrophobic blocks.

In another preferred embodiment, the AEM and/or the catalyst ink comprises a polymer based on a styrene-butadiene block copolymers (SEBS) with a tethered quaternary ammonium group through aromatic ring(s).

In another preferred embodiment, the AEM and/or the catalyst ink comprises a polymer based on ETFE, LDPE or HDPE irradiated with e-beam that may be tethered by a quaternary ammonium cationic group.

In one embodiment, the AEMEL of the present application includes one or more catalysts. In some embodiments, a catalyst is present to increase the reaction rate of the half reactions occurring at the cathode, anode, or both electrodes. Thus, the catalyst may increase the rate of formation of hydrogen gas, oxygen gas, or both. In some embodiments, the catalyst is an oxide, a combination of metals, a perovskite, a pure metal, or another material. In some embodiments, the catalyst is supported or unsupported. In some embodiments, platinum-group metals may be used as catalyst. In some embodiments, non-platinum-group metals may be used as catalyst.

In some embodiments, an anode catalyst may be RuO₂, IrO₂, spinel oxides such as Al_{0.5}Mn_{2.5}O₄, PbRuOₓ, FeₓNi_{y}OOH, IrRuO₂, perovskites, Mo (direct deposited), MoP, IrOₓ/NbOₓ, IrRuO₂/NbOₓ, NiFeCo, NiCe@NiFe/NF, Fe—CoP/NF, Co₃O₄, Fe_{0.33}Co_{0.66} P, Fe(PO₃)₂/Ni₂P, (Ni,Fe)OOH, Ni—Fe—OH@Ni₃S₂/NF, Ni(Fe)OₓH_{y}, NiₓFe_{y}O_{z}, NiFeOₓ, CoₓFe₃₋ₓO₄/CFP wherein x, y and z can be (0, 0.1, . . . , 2.0, 2.1, . . . ) and combinations thereof (including alloys). In some embodiments, a cathode catalyst may be NiₓMo_{y}, Pt/C, Pt alloys/ECS, Pt/ECS, Pt black, Pt alloys, Ni alloys, NiZn, NiMo, MoS₂/Ni₃S₂/NF, a-MoSₓ/CC, Co—Co₂P@NPC/rGO, Ni₂₍₁₋ₓ₎Mo₂ₓP/NF, Co_{2.90}B_{0.73}P_{0.27}/NF, F—Co₂P/Fe₂P/IF, Ni₂P/NF, CoP/Ni₅P₄/CoP, P—Fe₃O₄/IF, A-NiCo LDH/NF and combinations thereof, where ECS means engineered catalyst support. In some embodiments, atomic layer deposition (ALD) may be used to deposit either the cathode catalyst, anode catalyst or both.

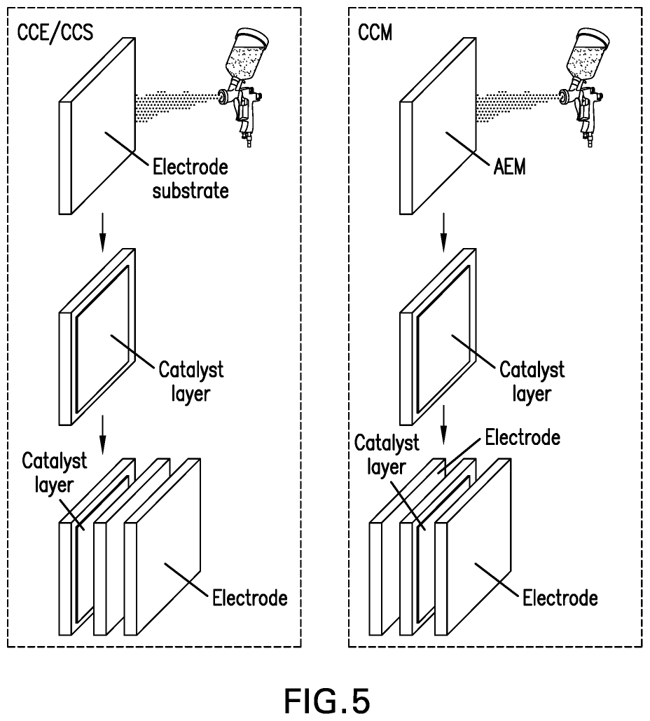

In some embodiments, one or more catalysts may be incorporated into a catalyst ink. The catalyst ink may be prepared by mixing the catalyst(s) with an ionomer resin, solvents, water, and additives. In some embodiments, additives such as polytetrafluoroethylene (PTFE), polyvinyl alcohol (PVA), fluorinated ethylene propylene (FEP), perfluoroalkoxy (PFA), polyacrylic acid (PAA), polyvinylidene fluoride (PVDF), polydimethylsiloxane (PDMS), polyamides (Nylon), polyethylene (PE), ethylene tetrafluoroethylene (ETFE) and/or others can be used to modify the mechanical and chemical properties of the catalyst ink. In some embodiments, non-ionic surfactants such as polyoxyethylene alkyl ether may be used too. Three commercial examples of these chemicals are the Teflon™ PTFE DISP 30, Teflon™ PFAD 335D and the Teflon™ FEPD 121 Fluoropolymer Dispersion (all of them by Chemours). In some embodiments, the amount of additives can be as high as 50 wt % in the catalyst ink mixture (defined as catalyst, ionomer and additives, but excluding solvents and water). In some embodiments, a catalyst ink may be coated on an anion exchange membrane, a porous transport layer, a gas diffusion layer, or a combination thereof. In some embodiments, the ink forms a moldable, clay-like layer that may be pressed onto the diffusion layers and/or membrane. When the catalyst ink is coated on an anion exchange membrane, it may be referred to as a catalyst coated membrane (or CCM). When the catalyst ink is coated on the gas diffusion layer and/or the porous transport layer, it may be referred to as a catalyst coated electrode (or CCE), or catalyst coated substrate (or CCS). This is exemplified in FIG. 5. In some embodiments, the catalyst ink may be independently molded (instead of coated) thanks to the use of additives that create a clay-like layer. This layer may then be pressed onto the diffusion layers and/or the membrane. In some embodiments, the catalyst layer may be created by atomic layer deposition (ALD).

In a preferred embodiment, the catalyst ink is a moldable, clay-like layer that is pressed onto the diffusion layers and/or membrane thanks to the addition of non-ionic surfactants and/or additives such as PTFE.

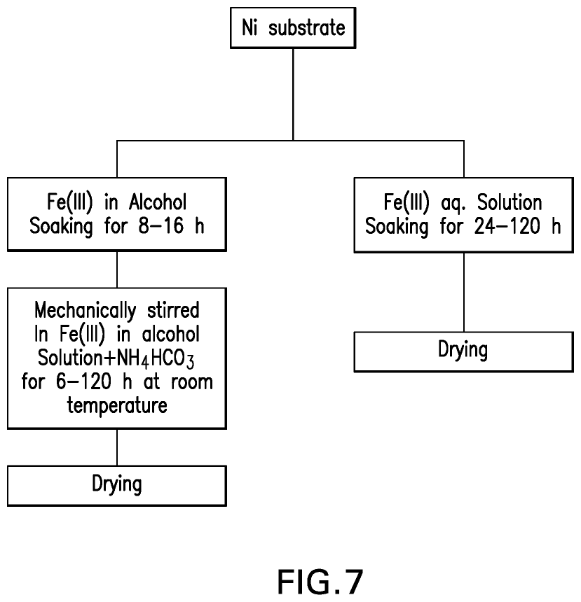

In some embodiments, the catalyst layer may be grown on the porous transport layer by corroding (hydrothermal deposition, electrodeposition, etc.) a metallic foam, fiber, or mesh in aqueous solutions with copper, lithium, iron, cerium, cobalt, zinc or nickel cations, or a combination thereof, and including dopants such as phosphorus, boron, fluorine, cobalt, or others. An example of such methodology is shown in FIG. 7. The catalyst layer may contain molybdenum, nickel, cobalt, cerium, iron, tin, sulfur, phosphorus, fluorine, oxygen, oxides, hydroxide, di-hydroxide and other materials, or a combination thereof. In some embodiment the catalyst may be supported on a conductive carbon support such as carbon, Vulcan, Ketjen black, etc. In some embodiment the catalyst may be supported on a non-ionic or ionic polymeric binder such as PTFE, PVA, PAA, PE, ETFE or PVDF, etc. In some embodiment the catalyst may be supported by ionic polymeric binders containing cationic protons or anionic hydroxide ions.

In another aspect, the AEMELs of the present application may be configured in a stack comprising a plurality of cells as shown in FIG. 2. In some embodiments, the bipolar plates can be shared between cells meaning they have flow fields machined on both sides. In some embodiments, multiple cells share the same water feed as well as gas exhaust. In some embodiments, the first and last flow field plates are called end plates and can have fittings that connect to the balance of plant. In some embodiments, the bipolar plates and end plates may be cooled or heated.

### Construction

AEMELs of the present application may be made by hot pressing the membrane/electrode assembly, roll coating the membrane (roll-to-roll), spray coating the membrane or electrodes, electrochemically growing catalysts on the electrodes, etc. The torque applied to the bolts of the stack, the water temperature and purity, the thickness of the different components and the amount of ionomer in the ink all play a role in the fabrication process. In some embodiments, a catalyst ink may be coated on an anion exchange membrane, a porous transport layer, or a gas diffusion layer, or a combination thereof.

In some embodiments, a catalyst may be grown on the gas diffusion layer and/or the porous transport layer. For instance, a metallic porous substrate is may be immersed with HCl or H₂SO₄ or other acids to remove residual oxides and then washed with water to remove such acid. At this point, nitrates (such as iron nitrate hexahydrate) and dopants (such as sodium fluoride) may be dissolved in water. The substrate is then immersed into the solution while oxygen is being bubbled through. After several hours, the desired iron-based self-supported catalyst is formed.

Methods of Using

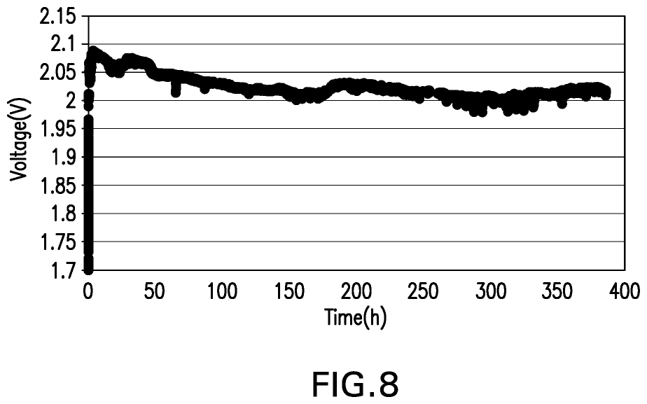

AEMELs of the present application may be operated by applying a voltage between the anode and the cathode. For electrolysis to occur, the voltage must be at least 1.23V. In certain embodiments, however, the voltage applied is as high as 3V per cell. In certain embodiments, the voltage is between 1.23V and 3V. In certain embodiments, the voltage is 1.3V, 1.4V, 1.5V, 1.6V, 1.7V, 1.8V, 1.9V, 2.0V, 2.1V, 2.2V, 2.3V, 2.4V, 2.5V, 2.6V, 2.7V, 2.8V, 2.9V, or 3.0V. Voltage recorded over time is shown in FIG. 8.

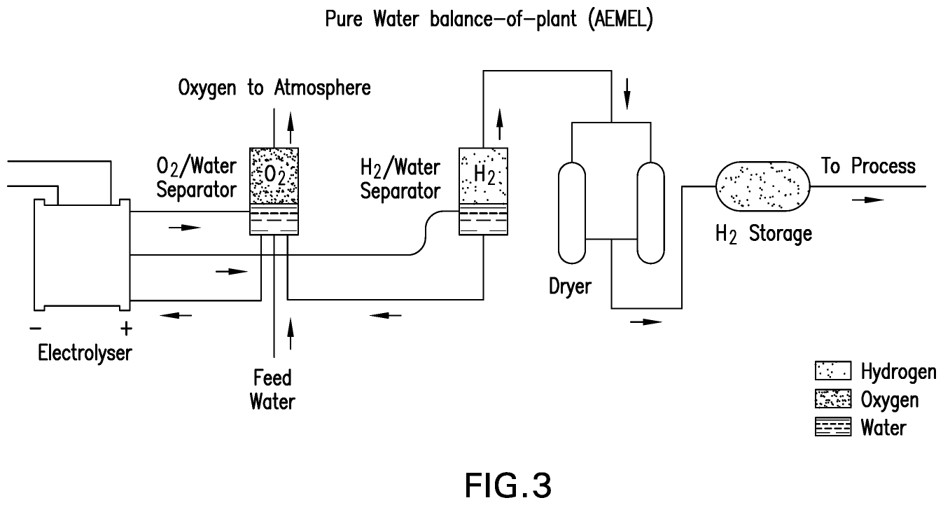

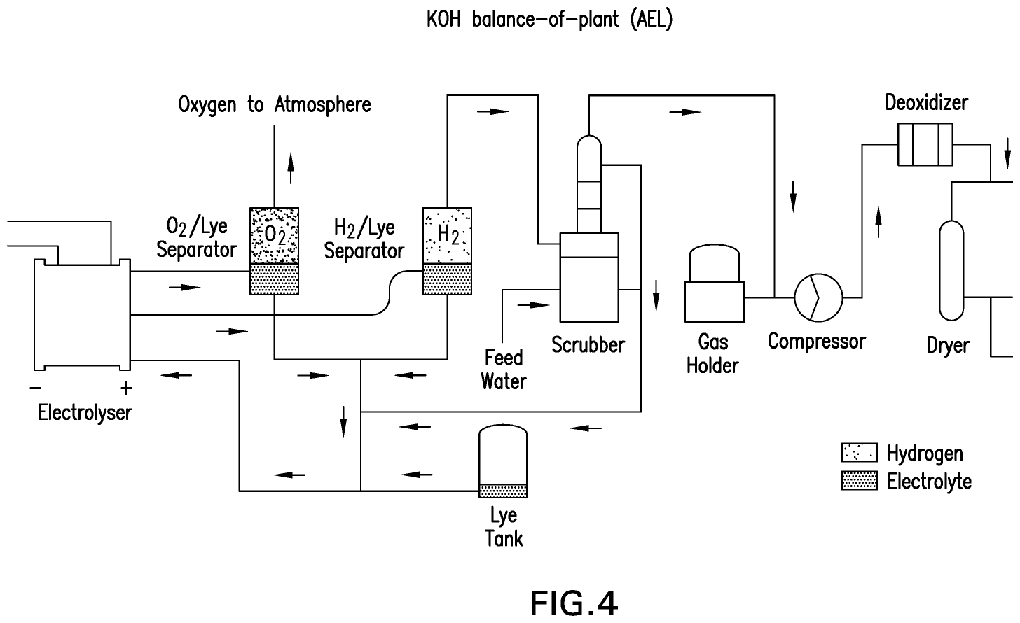

AEMELs according to the present application may be used as shown in the process flow diagram shown in FIG. 3. Such a process is much simpler than the process flow diagram of a typical alkaline water electrolyzer (AEL) as shown in FIG. 4. The construction of the AEMELs according to the present application as described above also makes such AEMELs substantially less expensive than PEMELs while retaining high current densities.

In another aspect, AEMELs of the present application include highly conductive anion exchange membranes having high chemical stability in pure water. As compared to other AEMELs, the AEMELs of the present application are able to operate for a longer lifetime when operated at higher voltages. In particular, when operated at current densities above 0.5 amps/cm², the anion exchange membrane is able to operate for at least 1000 hours before needing replacement. In some embodiments, the electrolyzer is operated at 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4 or 2.5 amps/cm². In some embodiments, the electrolyzer is operated at 50, 100, 150, 200, 250, 300, 350, 400, 450, 500, 550, 600, 650, 700, 750, 800, 850, 900, or 950 mA/cm².

### Further Embodiments

1.1 A water electrolyzer comprising:
   an anode comprising a quantity of anode catalyst;
   a cathode comprising a quantity of cathode catalyst; and
   an anion exchange membrane interposed between said anode and said cathode;
   wherein the water electrolyzer utilizes tap water or purified water with no additives such as salts, acids, or bases.
1.2 The water electrolyzer of 1.1,
   wherein the anion exchange membrane comprises a material selected from (a) a polymer based on poly(aryl piperidinium) which comprises either a piperidone monomer or a 3-oxo-6-azoniaspiro[5.5]undecane salt monomer, an aromatic and, optionally, a trifluoroacetophenone monomeric group, (b) a multiblock copolymer comprising one or more norbornene-based hydrophilic blocks and one or more norbornene-based or alkene-based hydrophobic blocks, (c) a polymer based on a styrene-butadiene block copolymers (SEBS) with a tethered quaternary ammonium group through aromatic rings, and (d) a polymer based on ETFE, LDPE or HDPE irradiated with e-beam that may be tethered by a quaternary ammonium cationic group.
1.3 The water electrolyzer of any of 1.1 to 1.2,
   wherein the cathode is a dry cathode.
1.4 The water electrolyzer of any of 1.1 to 1.3,
   further comprising an anode catalyst and a cathode catalyst.
1.5 The water electrolyzer of any of 1.1 to 1.4,
   wherein the anode catalyst comprises one or more metal catalysts, said metal being a metal other than Ru, Rh, Pd, Ag, Re, Os, Ir, Pt or Au.
1.6 The water electrolyzer of any of 1.1 to 1.5,
   wherein the anion exchange membrane has a thickness of from 1 to 200 micrometers.
1.7 The water electrolyzer of any of 1.1 to 1.6,
   further comprising a porous transport layer and a gas transport layer.
1.8 The water electrolyzer of any of 1.1 to 1.7,
   wherein the anode plate comprises a stainless steel plate with a pocket-like flow field that is optionally coated.
1.9 The water electrolyzer of any of 1.1 to 1.8,
   wherein the cathode plate comprises a stainless steel plate with a pocket-like flow field that is optionally coated.
1.10 The water electrolyzer of any of 1.1 to 1.9,
   further comprising a bipolar plate, wherein the bipolar plate comprises a stainless steel plate with pocket-like flow fields on both sides that is optionally coated.
1.11 The water electrolyzer of any of 1.7-1.10,
   wherein the porous transport layer comprises a nickel material.
1.12 The water electrolyzer of any of 1.7-1.10,
   wherein the gas diffusion layer comprises a nickel material.
1.13 The water electrolyzer of any of 1.1 to 1.12, further comprising:
   a catalyst ink comprising (1) the anode catalyst or the cathode catalyst, (2) an ionomer, (3) solvents and/or water, and (4) additives.
1.14 The water electrolyzer of 1.13,
   wherein the ionomer is selected from the group consisting of (1) a polymer based on poly(aryl piperidinium) which comprises either a piperidone monomer or a 3-oxo-6-azoniaspiro[5.5]undecane salt monomer, an aromatic and, optionally, a trifluoroacetophenone monomeric group, (2) a multiblock copolymer comprising one or more norbornene-based hydrophilic blocks and one or more norbornene-based or alkene-based hydrophobic blocks, (3) a polymer based on a styrene-butadiene block copolymers (SEBS) with a tethered quaternary ammonium group through aromatic rings, and (4) a polymer based on ETFE, LDPE or HDPE irradiated with e-beam that may be tethered by a quaternary ammonium cationic group.
1.15 The water electrolyzer of 1.13,
   wherein the additives are selected from the group consisting of polytetrafluoroethylene (PTFE), polyvinyl alcohol (PVA), fluorinated ethylene propylene (FEP), perfluoroalkoxy (PFA), polyacrylic acid (PAA), polyvinylidene fluoride (PVDF), polydimethylsiloxane (PDMS), polyamides (Nylon), polyethylene (PE), ethylene tetrafluoroethylene (ETFE) and/or non-ionic surfactants (such as polyoxyethylene alkyl ether).
1.16 The water electrolyzer of 1.15,
   wherein the additives give the ink the mechanical properties of a clay-like material that may be molded, rolled-pressed and/or hot-pressed.
2.1 A method of operating a water electrolyzer, the method comprising:
   providing a water electrolyzer according to any of 1.1 to 1.16; and
   providing a voltage across the anode and cathode.
2.2 The method of claim 2.1,
   wherein the voltage is below 2.5V per cell.
2.3 The method of claim 2.2,
   wherein the anion exchange membrane is able to operate for at least 1000 hours before needing replacement.

### EXAMPLES

### Example 1—AEMEL According to Present Application

An AEMEL was constructed to demonstrate hydrogen production using pure deionized water and low-cost plates. The AEMEL specifications were:
a) A single cell structure (not a multicell stack).
b) The anode plate was made of nickel, and the cathode plate was made of graphite.
c) The PTL was made of nickel foam, and the GDL was made of carbon paper.
d) The anion exchange membrane and ionomer were chosen to be a polymer based on poly(aryl piperidinium).
e) A source of electrical energy was used to apply a voltage of less than 2.2V between the anode and cathode of each cell.

The membrane-electrode assembly was prepared as follows. First, the cathode catalyst, Pt/C, was mixed with the ionomer solution keeping the ionomer weight percent below 40% and a final catalyst loading of less than 5 mg/cm². This ink was then coated on the membrane (CCM). Second, the anode catalyst, IrO₂, was mixed with the ionomer solution keeping the ionomer weight percent below 40% and a final catalyst loading of less than 5 mg/cm². This ink was then coated on the substrate (CCE). The entire membrane/electrode assembly was pressed for several minutes before assembling. The cell had an active area of 25 cm² and was run at 90 Celsius. Pure deionized water was flown only at the anode side.

This water electrolyzer showed 200 mA/cm² at a voltage of less than 2.2V for many hours. The inventors believe this example is the most stable pure-water AEMEL ever developed.

### Example 2—AEMEL According to Present Application

An AEMEL was constructed to demonstrate hydrogen production from an AEM electrolyzer stack using pure deionized water, low-cost plates, and low-cost catalysts. The specifications were:
a) Four-cell stack AEMEL.
b) The anode plate, bipolar plates, and cathode plate were made of stainless steel 316.
c) A stainless steel mesh was chosen as PTL, and carbon paper was used as GDL.
d) The anion exchange membrane and ionomer were chosen to be a multiblock copolymer comprising one or more norbornene-based hydrophilic blocks and one or more norbornene-based or alkene-based hydrophobic blocks.
e) A source of electrical energy was used to apply a voltage of less than 2.2V between the anode and cathode.

The membrane-electrode assembly was prepared as follows. First, the cathode catalyst, nickel alloy, was mixed with the ionomer solution keeping the ionomer weight percent below 50% and a final catalyst loading of less than 5 mg/cm². This ink was then coated on the membrane (CCM). Second, the anode catalyst, molybdenum-based, was mixed with the ionomer solution keeping the ionomer weight percent below 50% and a final catalyst loading of less than 5 mg/cm². This ink was then coated on a decal (PTFE-coated fiber glass) and hot lamination was performed to coat it at the anode side. The cell had an active area of 25 cm² and was run at 90 Celsius. Pure deionized water was flown only at the anode side. This water electrolyzer showed 200 mA/cm² at a voltage of less than 2.2V per cell for many hours.

### Example 3—AEMEL According to Present Application

An AEMEL was constructed to demonstrate hydrogen production from an AEM electrolyzer using pure deionized water and different coating techniques. The specifications were:
a) A single cell structure (not a multicell stack).
b) The anode plate was made of nickel, and the cathode plate was made of graphite.
c) The PTL was made of nickel foam, and the GDL was made of carbon paper.
d) The anion exchange membrane and ionomer were chosen to be a polymer based on a styrene-butadiene block copolymers (SEBS) with a tethered quaternary ammonium group through aromatic rings.
e) A source of electrical energy was used to apply a voltage of less than 2.2V between the anode and cathode.

The membrane-electrode assembly was prepared as follows. First, the cathode catalyst, Pt/C, was mixed with the ionomer solution keeping the ionomer weight percent below 40% and a final catalyst loading of less than 5 mg/cm². This ink was then coated on the PTL (CCE). Second, the anode catalyst was electrochemically grown on the nickel foam and a final catalyst loading of less than 5 mg/cm² was obtained. The cell had an active area of 25 cm² and was run at 60 Celsius. Pure deionized water was flown only at the anode side. This water electrolyzer showed 200 mA/cm² at a voltage of less than 2.2V for many hours.

The examples given above are merely illustrative and are not meant to be an exhaustive list of all possible embodiments, applications, or modifications of the present electrochemical device. Thus, various modifications and variations of the described methods and systems of the invention will be apparent to those skilled in the art without departing from the scope and spirit of the invention. Although the invention has been described in connection with specific embodiments, it should be understood that the invention as claimed should not be unduly limited to such specific embodiments. Indeed, various modifications of the described modes for carrying out the invention which are obvious to those skilled in the chemical arts or in the relevant fields are intended to be within the scope of the appended claims.

### Example 4—AEMEL According to Present Application

An AEMEL was constructed to demonstrate hydrogen production using pure water and low-cost plates. The AEMEL specifications were:
f) A single cell structure (not a multicell stack).
g) The anode and cathode plates were made of stainless steel 316.
h) The PTL and GDL were made of nickel foams with similar porosities.
i) The anion exchange membrane and ionomer were chosen to be a multiblock copolymer comprising one or more norbornene-based hydrophilic blocks and one or more norbornene-based or alkene-based hydrophobic blocks.
j) A source of electrical energy was used to apply a voltage of less than 2.2V between the anode and cathode of each cell.

The membrane-electrode assembly was prepared as follows. First, the cathode catalyst, NiMo on carbon, was mixed with the ionomer solution keeping the ionomer weight percent below 40%. Additives such as PTFE, PAA, PVA and PFA were added too. This clay-like ink was then molded and pressed on the GDL. Second, the anode catalyst, NiₓFe_{y}O_{z}, was mixed with the ionomer solution keeping the ionomer weight percent below 40%. This clay-like ink was then molded and pressed on the PTL.

The entire membrane/electrode assembly was pressed before assembling. The cell had an active area of 25 cm² and was run at 60 Celsius. Pure water was flown only at the anode side. This water electrolyzer showed 500 mA/cm² at a voltage of less than 2.5V for many hours.

### Example 5—AEMEL According to Present Application

An AEMEL was constructed to demonstrate hydrogen production using pure deionized water, low-cost plates, and using low cost OER catalyst. The AEMEL specifications were:
k) A single cell structure (not a multicell stack).
l) The anode plate was made of stainless steel, and the cathode plate was made of graphite.
m) The PTL was made of nickel foam, and the GDL was made of carbon paper.
f) The anion exchange membrane and ionomer were chosen to be a polymer based on multiblock copolymer comprising one or more norbornene-based hydrophilic blocks and one or more norbornene-based or alkene-based hydrophobic blocks.
n) A source of electrical energy was used to apply a voltage of less than 2.2V between the anode and cathode of each cell.

The membrane-electrode assembly was prepared as follows. First, the anode PTL was soaked in an Fe(III) solution for 96 h. This PTL was later air-dried overnight. Second, the cathode catalyst, PtNi/C, was mixed with the ionomer solution keeping the ionomer weight percent below 40% and a final catalyst loading of less than 5 mg/cm². This ink was then coated on the carbon substrate (CCE). The entire membrane/electrode assembly was pressed for several minutes before assembling. The cell had an active area of 25 cm² and was run at 70 Celsius. Pure deionized water was flown only at the anode side.

This water electrolyzer showed 200 mA/cm² at a voltage of less than 2.2V for many hours.

### Example 6—AEMEL According to Present Application

An AEMEL was constructed to demonstrate hydrogen production from an AEM electrolyzer stack using pure deionized water, low-cost plates, and low-cost catalysts. The specifications were:
g) Four-cell stack AEMEL.
h) The anode plate, bipolar plates, and cathode plate were made of stainless steel 316.
i) A stainless-steel mesh was chosen as PTL, and carbon paper was used as GDL.
j) The anion exchange membrane and ionomer were chosen to be a multiblock copolymer comprising one or more norbornene-based hydrophilic blocks and one or more norbornene-based or alkene-based hydrophobic blocks.
k) A source of electrical energy was used to apply a voltage of less than 2.2V between the anode and cathode.

The membrane-electrode assembly was prepared as follows. First, the cathode catalyst, PtNi/C, was mixed with the ionomer solution keeping the ionomer weight percent below 50% and a final catalyst loading of less than 5 mg/cm². This ink was then coated on the substrate (CCE). Second, the anode PTL, Ni foam was soaked in Fe(III) in ethanol solution for 8-16 h. This PTL was later soaked in a separate Fe(III) in ethanol solution with NH₄HCO₃ with mechanical stirring at 30° C. The cell had an active area of 25 cm² and was run at 70 Celsius. Pure deionized water was flown only at the anode side. This water electrolyzer showed 200 mA/cm² at a voltage of less than 2.2V per cell for many hours.

The examples given above are merely illustrative and are not meant to be an exhaustive list of all possible embodiments, applications, or modifications of the present electrochemical device. Thus, various modifications and variations of the described methods and systems of the invention will be apparent to those skilled in the art without departing from the scope and spirit of the invention. Although the invention has been described in connection with specific embodiments, it should be understood that the invention as claimed should not be unduly limited to such specific embodiments. Indeed, various modifications of the described modes for carrying out the invention which are obvious to those skilled in the chemical arts or in the relevant fields are intended to be within the scope of the appended claims.

1. A water electrolyzer comprising:
an anode comprising a quantity of anode catalyst;
a cathode comprising a quantity of cathode catalyst; and
an anion exchange membrane interposed between said anode and said cathode;
wherein the water electrolyzer utilizes tap water or purified water with no additives such as salts, acids or bases.

2. The water electrolyzer of claim 1,
wherein the anion exchange membrane comprises a material selected from (a) a polymer based on poly(aryl piperidinium) which comprises either a piperidone monomer or a 3-oxo-6-azoniaspiro[5.5]undecane salt monomer, an aromatic and, optionally, a trifluoroacetophenone monomeric group, (b) a multiblock copolymer comprising one or more norbornene-based hydrophilic blocks and one or more norbornene-based or alkene-based hydrophobic blocks, (c) a polymer based on a styrene-butadiene block copolymers (SEBS) with a tethered quaternary ammonium group through aromatic rings, and (d) a polymer based on ETFE, LDPE or HDPE irradiated with e-beam that may be tethered by a quaternary ammonium cationic group.

3. The water electrolyzer of claim 1,
wherein the cathode is a dry cathode.

4. The water electrolyzer of claim 3,
wherein at the dry cathode, no liquid is present other than water.

5. The water electrolyzer of claim 1,
wherein the anode catalyst comprises one or more metal catalysts, said metal being a metal other than Ru, Rh, Pd, Ag, Re, Os, Ir, Pt or Au.

6. The water electrolyzer of claim 1,
wherein the anion exchange membrane has a thickness of from 1 to 200 micrometers.

7. The water electrolyzer of claim 1,
further comprising a porous transport layer and a gas transport layer.

8. The water electrolyzer of claim 1,
wherein the anode plate comprises a stainless steel plate with a pocket-like flow field that is optionally coated.

9. The water electrolyzer of claim 1,
wherein the cathode plate comprises a stainless steel plate with a pocket-like flow field that is optionally coated.

10. The water electrolyzer of claim 1,
further comprising a bipolar plate, wherein the bipolar plate comprises a stainless steel plate with pocket-like flow fields on both sides that is optionally coated.

11. The water electrolyzer of claim 7,
wherein the porous transport layer comprises a stainless steel nickel material.

12. The water electrolyzer of claim 7,
wherein the gas diffusion layer comprises a stainless steel nickel material.

13. The water electrolyzer of claim 1,
further comprising:
a catalyst ink comprising (1) the anode catalyst or the cathode catalyst, (2) an ionomer, (3) solvents and/or water, and (4) additives.

14. The water electrolyzer of claim 13,
wherein the ionomer is selected from the group consisting of (1) a polymer based on poly(aryl piperidinium) which comprises either a piperidone monomer or a 3-oxo-6-azoniaspiro[5.5]undecane salt monomer, an aromatic and, optionally, a trifluoroacetophenone monomeric group, (2) a multiblock copolymer comprising one or more norbornene-based hydrophilic blocks and one or more norbornene-based or alkene-based hydrophobic blocks, (3) a polymer based on a styrene-butadiene block copolymers (SEBS) with a tethered quaternary ammonium group through aromatic rings, and (4) a polymer based on ETFE, LDPE or HDPE irradiated with e-beam that may be tethered by a quaternary ammonium cationic group.

15. The water electrolyzer of claim 13,
wherein the additives are selected from the group consisting of polytetrafluoroethylene (PTFE), polyvinyl alcohol (PVA), fluorinated ethylene propylene (FEP), perfluoroalkoxy (PFA), polyacrylic acid (PAA), polyvinylidene fluoride (PVDF), polydimethylsiloxane (PDMS), polyamides (Nylon), polyethylene (PE), ethylene tetrafluoroethylene (ETFE) and/or non-ionic surfactants (such as polyoxyethylene alkyl ether).

16. The water electrolyzer of claim 15,
wherein the additives give the ink the mechanical properties of a clay-like material that may be molded, rolled-pressed and/or hot-pressed.

17. A method of operating a water electrolyzer, the method comprising:
providing a water electrolyzer according to claim 1; and
providing a voltage across the anode and cathode.

18. The method of claim 16,
wherein the voltage is below 2.5V per cell.

19. The method of claim 17,
wherein the anion exchange membrane is able to operate for at least 1000 hours before needing replacement.
